(19) United States
(12) Patent Application Publication
(10) Pub. No.: US 2018/0197241 A1
(43) Pub. Date: Jul. 12, 2018

(54) SYSTEMS AND METHODS OF SEQUENCING OR COMBINING MULTIPLE RELATED, BUT DIFFERENT, TRANSACTION REQUESTS INTO A SINGLE TRANSACTION

(71) Applicants: Michael CHAPMAN, Alexandria, VA (US); Eric FOLKEMER, New York, NY (US); Annemarie TIERNY, Highlands, NJ (US); Alex ZINDER, New York, NY (US); Mykhailo SERDIUK, Kiyv (UA)

(72) Inventors: Michael CHAPMAN, Alexandria, VA (US); Eric FOLKEMER, New York, NY (US); Annemarie TIERNY, Highlands, NJ (US); Alex ZINDER, New York, NY (US); Mykhailo SERDIUK, Kiyv (UA)

(21) Appl. No.: 15/864,942

(22) Filed: Jan. 8, 2018

Related U.S. Application Data
(60) Provisional application No. 62/444,229, filed on Jan. 9, 2017.
(60) Provisional application No. 62/459,905, filed on Feb. 16, 2017.

(51) Int. Cl. G06Q 40/04; G06F 17/30

(52) U.S. Cl. CPC G06Q 40/04; G06F 17/30563

(57) ABSTRACT

In certain examples embodiments, an sequenced transaction process is provided that treats multiple individual transaction processes as a single transaction. Participants are able to submit requests (e.g., orders) via a client computer system specifying a total amount (e.g., in volume or other amount) that they are will to commit to against. The participants may also specify specific amounts for resources that are being matched during the sequenced transaction process. The sequenced transaction process then determines how much of each resource will be matched against each of the submitted requests.

### CROSS REFERENCE(S) TO RELATED APPLICATION(S)

This application claims priority to U.S. Provisional Application Nos. 62/444,229 (filed Jan. 9, 2017) and 62/459,905 (filed Feb. 16, 2017), the entire contents of each being incorporated by reference.

### TECHNICAL OVERVIEW

The technology described herein relates to data transaction processing. More particularly, the technology described herein relates to combining, sequencing, or otherwise grouping multiple different types of data transaction requests in a single transaction from the perspective of a transaction requestor.

### INTRODUCTION

Transaction processing plays an important role in computing technology from database systems, to graphics processing, to complex distributed systems, and other areas of computer technology. In a database example, a transaction request may to insert a new record into a table of the database. A database that receives a request performs data transaction processing that results in adding a new record into a table of the database.

New techniques for more efficient or optimized transaction processing are continually sought after. For example, techniques for how matching processes and individual transaction requests may be linked or sequenced together may be sought after.

### SUMMARY

In certain examples embodiments, multiple different data transaction processes are sequenced together to form a sequenced data transaction process that performs multiple separate data transaction processes as a single overall transaction. Client computer systems submit data transaction requests specifying a total that they are will to commit to against a group of resources. Contra-side data transaction requests may also be submitted on a per resource basis for resources in the group. Each resource has its own data transaction process that is used to match the opposing side data transaction requests. When client computer systems submit data transaction requests against the group of resources an indication of which ones of the individual resources that the request is eligible to be executed against may be provided. The sequenced data transaction process then determines, for each of the individual data transaction processes that make up the sequence, how the data transaction requests will be matched during each of the individual, but sequenced, data transaction processes. Thus, a single data transaction request can be used in multiple different transactions without having client systems submit duplicate (or similar) transaction requests for each of the individual data transaction processes.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 illustrates a non-limiting example function block diagram of a computer-implemented auction system coupled via a network to a client system configured to create and submit orders;

FIG. 2 shows an illustrative view of how a fund with multiple different assets that have individually performed auction processes are handled by a grouped or sequenced auction process;

FIGS. 3A, 3B, and 3C are signal diagrams that show how a sequenced auction process is performed using the example system shown in FIG. 1; and

FIG. 4 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

In certain example embodiments, a computer system (e.g., an auction computer system) is configured to perform multiple separate data transaction processes (e.g., processes that determine matches or transactions between opposing data transaction requests) for related but distinctly identified resources, which may also be referred to as assets. In certain examples, the data transaction processes are computer-implemented auction processes that are executed, from the perspective of an order submitting client, as one auction or one data transaction process. Client computer systems may submit electronic data transaction requests (e.g., also referred to as “orders” herein) via a single interface and via a single request. The single order is then used over multiple separate, but linked data transaction processes (e.g., auctions) performed by the auction computer system. In certain examples, a single order that can execute over multiple separate auctions may be a multi-resource or multi-asset order.

In certain example embodiments, a single data transaction request (e.g., a buy order) includes instructions (e.g., as one or more parameters) about the maximum (or minimum in the case of a sell order) value for how executions will occur across the multiple separate, but related, auctions. Each order (e.g., both sell and buy orders) may (or must) specify a price for individual auctions in order to participate. The computer system determines a sequence that the multiple auctions for the different assets will occur and then sequentially performs auctions for each of the different assets. Each auction includes a determination (e.g., as part of the transaction processing) of a transaction price, amount, and how the buy and sell orders for that auction will be matched. In certain examples, orders (e.g., buy orders) that remain unexecuted at the end of one auction process may participate in subsequent auctions. In certain examples, the computer system programmatically determines the execution price for a given auction that maximizes the “size” or value of the auction (e.g., as quantified by shares), execution value, or nominal value.

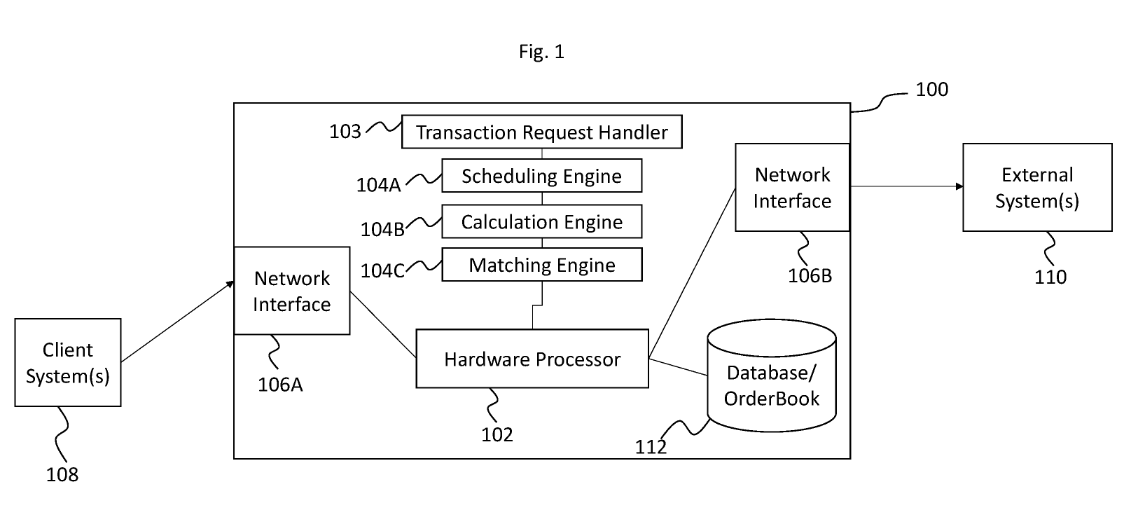

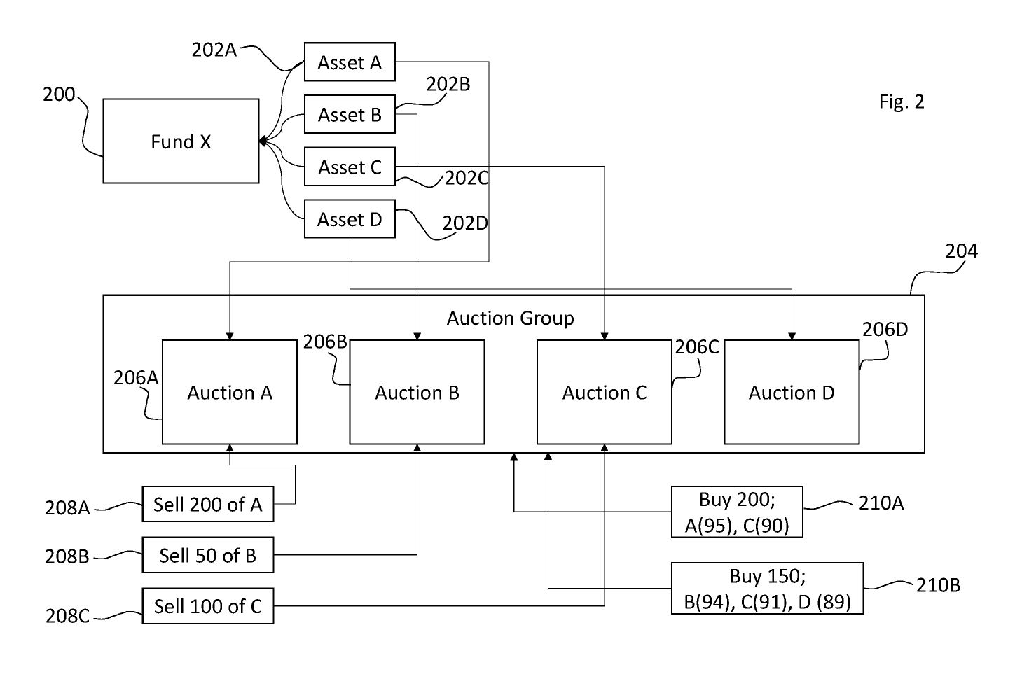

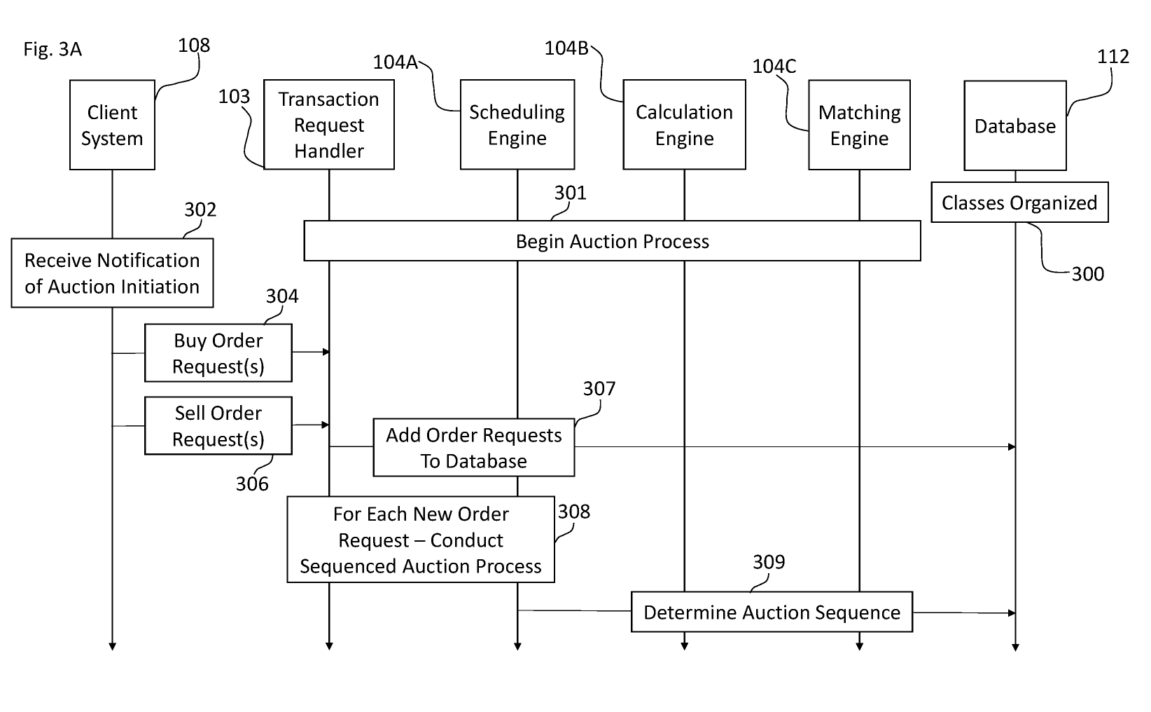

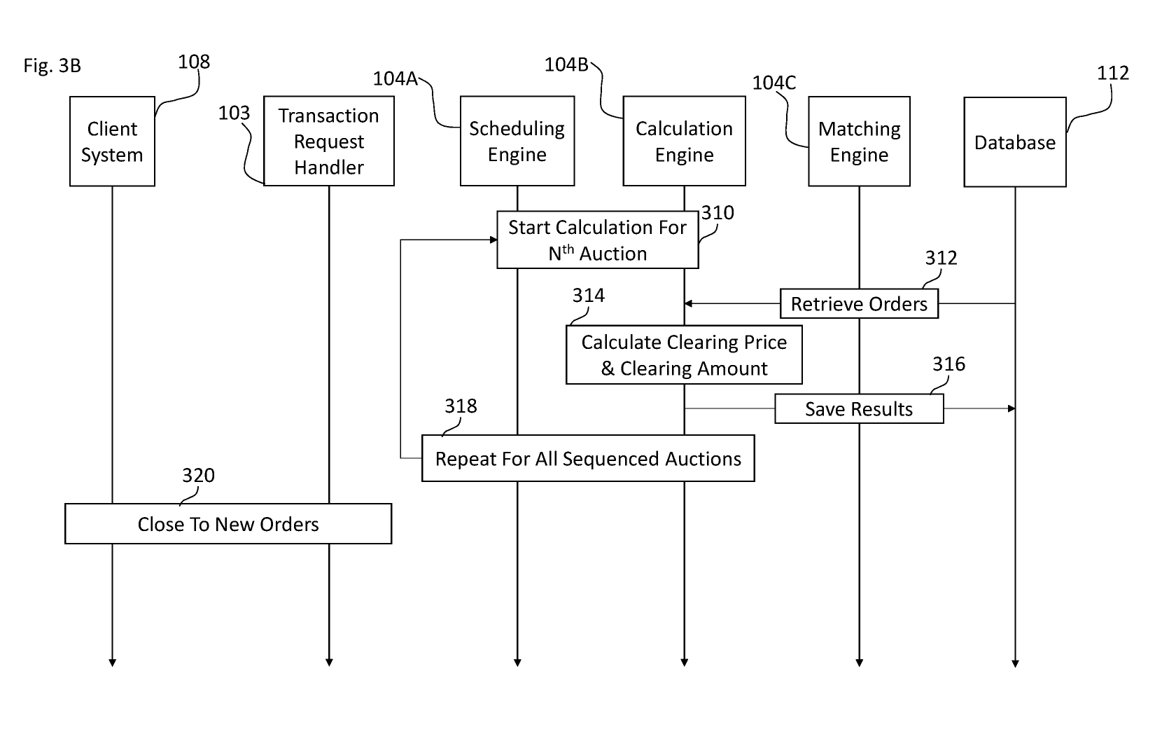

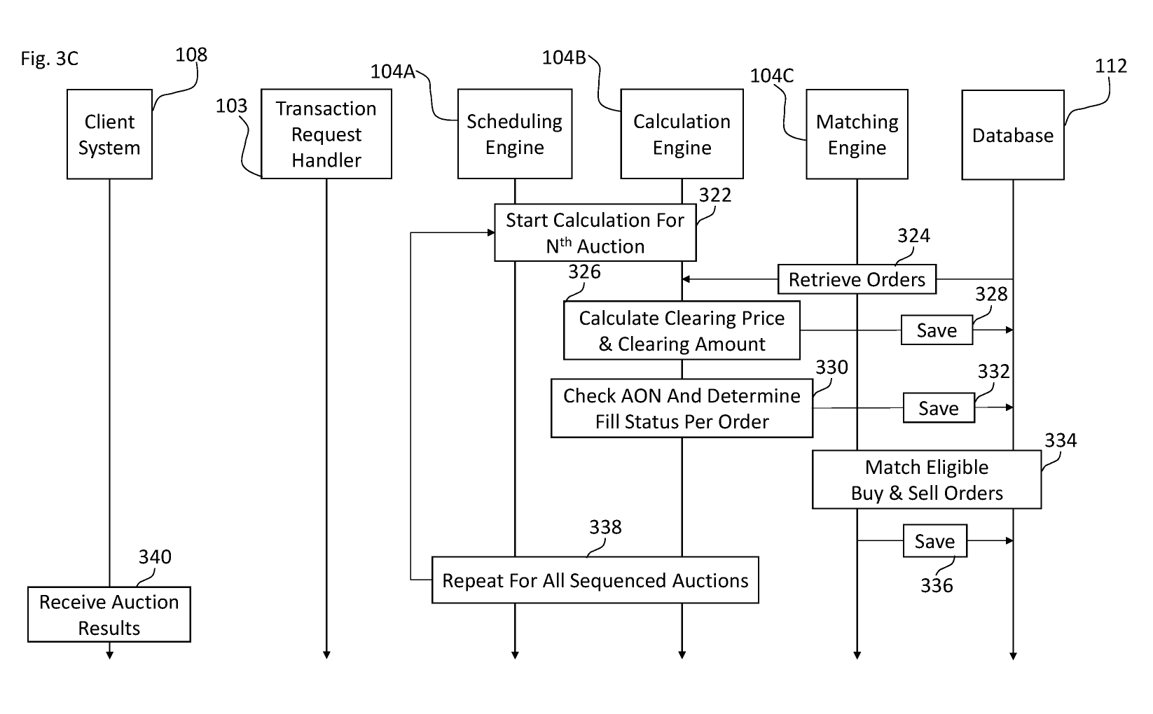

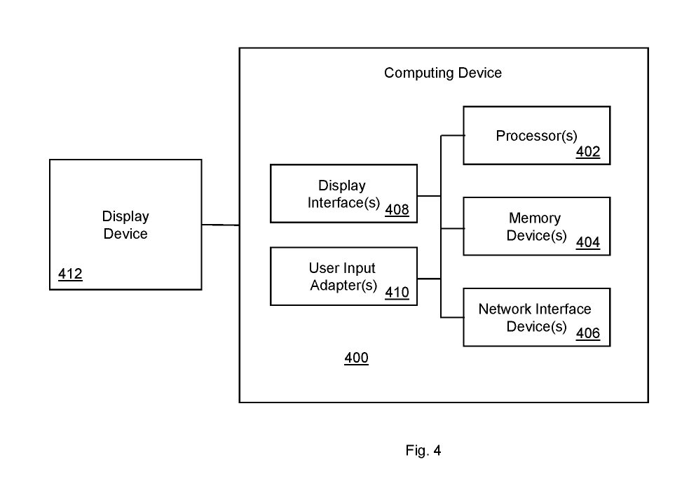

FIG. 1 illustrates a non-limiting example function block diagram of a computer-implemented auction system (auction system) coupled via a network to a client system that is configured to submit orders to the auction system. FIG. 2 shows an illustrative view of how a group of multiple different assets that have individually performed auction processes may be arranged using the system of FIG. 1. FIGS. 3A and 3B are signal diagrams that show an example multi-stage auction for a group of assets (such as those shown in FIG. 2). FIG. 4 shows an example hardware architecture used, in some embodiments, to implement the features shown in FIG. 1 through FIG. 3B.

In many places in this document, software modules (e.g., transaction request handler 103, scheduling engine 104A, calculation engine 104B, and matching engine 104C) and actions performed by such software modules are described. This is done for ease of description; it should be understood that, whenever it is described in this document that a software module performs any action, the action is in actuality performed by underlying hardware elements (such as a hardware processor (e.g., a CPU), a memory device, and the like) according to the instructions that comprise the software module. Further details regarding this are provided below in, among other places, the description of FIG. 4.

### Description of FIG. 1

FIG. 1 shows a block diagram of an example embodiment of a computer system. In this example, the computer system may be an auction computer system 100 (auction system) that communicates with client systems 108 that is configured to submit data transaction requests (e.g., orders) to the auction system 100 via network interface 106A.

Auction system 100 includes a hardware processor 102 (e.g., such as processor 402 in FIG. 4) that implements transaction request handler 103, scheduling engine 104A, calculation engine 104B, and matching engine 104C, which may each be separate programs or routines (e.g., software programs, libraries, or other programmed functionality) executed by the auction system 100. In certain examples, the functionality carried out by each of the transaction request handler 103, scheduling engine 104A, calculation engine 104B, and matching engine 104C may be executed on different computer systems (e.g., a distributed computer system) such that these different elements communicate via a network. Auction system 100 also includes a database 112 that may serve as or include an order book data structure (e.g., for holding dual lists, which may be sorted, of orders that have been submitted). Auction system 100 also includes network interface 1068 used to communicate with external system(s) 110 and/or between computing nodes that makeup the auction system 100 (e.g., in the case of a distributed system).

Transaction request handler 103 handles incoming data transaction requests (e.g., a data transaction request that is included in an electronic data message) from client system(s) 108. As noted above, one example of a data transaction request is an order (e.g., a buy or sell order). In certain example embodiments, incoming order may (e.g., must) specify an amount (e.g., $100,000) and prices for one or more of the assets that are grouped together (e.g., a bid of $100,000 for asset C, and a bid of $90,000 for asset B).

In certain example embodiments, an incoming order may include a percentage of the NAV (Net Asset Value) of the asset being auctioned. In such instances, the system 100 may automatically determine the “price” of order as a function of the NAV of the asset, the provided percentage, and the amount specified in the order. For example, if an incoming order has a nominal value of $200,000 and the NAV of one of the assets in the sequential auction process is $100,000, then the incoming order may include, as the order “price,” 0.50 (50%) of the NAV for that asset. Once the new order is received, the system 100 may calculate a bid price for the asset as being $50,000 and use the 50,000 value to eventually determine the per price share (e.g., $0.25) of the bid for that asset of this new order. Thus, instead of providing a price representing a minimally desirable total transaction value (e.g., $50,000), auction participants may provide their bid amounts as a percentage of a predefined value (e.g., the NAV).

In certain examples, a client may only include prices for a partial subset of all of the assets that are grouped together (e.g., prices for 2 out of 3 of the assets that will be in a sequential auction, but not for the third asset). Once a new order is received, it may be added to the order book and/or database 112 for future processing (e.g., to be used when the sequential auction process begins).

New buy orders received via the transaction request handler 103 may be validated by checking to ensure they include the total notional value of securities to be bought (or, in alternative implementations, the total amount the client is willing to spend) along with a list of assets and corresponding prices (or percentages of, for example, the NAV of an asset). Each one of the assets in the list may have an asset identifier (e.g., that uniquely identifies it from other assets) and a price for which the client is ready to purchase shares of this asset.

Newly received sell orders may also be validated to ensure the sell order includes an identifier of the asset being sold, a total notional value for the asset, and the price at least for which the client is ready to sell the asset (which may be expressed as a total value or a percentage of NAV).

Scheduling engine 104A is responsible for determining or maintaining the sequence of the auctions for the multiple different assets.

Generally, each distinct asset that can be traded will have its own corresponding auction process. For example, referring to FIG. 2, Assets A, B, C, and D, will have corresponding auctions A, B, C, and D (e.g., each being a separate data transaction process that is part of an overall sequenced data transaction process). Scheduling engine 104 may determine the order in which the various auctions for such assets may be executed. In certain examples, scheduling engine 104 may determine the order dynamically based on the amount of interest in the individual assets. For example, the more clients that include a price for a given asset may raise the priority of the asset. If there is more interest in asset D (e.g., 100 clients provided a price) than asset A (only 5 clients provided a price), then scheduling engine 104 may schedule auction D before auction A. In other examples, the order may be reversed (e.g., more interest may decrease the priority within the auction sequence). In certain examples, the order of the auctions for each individual asset may be preset (e.g., based on an auction administrator-definable configuration). In certain examples, scheduling engine 104A may dynamically sort the assets (and thus the corresponding auctions) based on properties associated with the assets. For example, each asset may have a corresponding fee that is attached to that asset. The scheduling engine 104 may sort or select the assets based on that fee. In certain examples, each asset has a corresponding fee class and the asset with the lowest fee class is first in the sequenced auction process, followed by the next lowest fee class, and so on until the auction for the highest fee class is executed last within the sequence. The scheduling engine 104 accordingly arranges or schedules the sequence for the auctions for the multiple assets that are contained within a given fund or collection assets.

For each sequenced auction, the calculation engine 104B determines the clearing price and clearing amount per auction. In other words, the calculation engine 104B attempts to choose a single clearing price that maximizes shares, units, size, transaction value, nominal value, commitment transferred, or other quantity (e.g., the clearing amount) between sell orders and buy orders for the given asset. The output from the calculation engine 1048 includes a list of sell and buy orders that are used by the matching engine 104C to construct transactions between the buy and sell orders.

In certain example embodiments, the calculation engine 104B can be used to provide a real time data feed of current buy and sell orders, the clearing price, the clearing amount, etc. . . . In a real-time data feed example, each time a new order is received, the functionality of the calculation engine 1048 may be executed and the resulting outputs from the calculation engine 104B can be reported via the real time data feed (e.g., which may be output to a display, or electronically transmitted to other computers over a network).

The matching engine 104C takes the list of sell and buy orders that are to be matched and determines or constructs transactions between those orders. In certain examples, the matching engine 104C seeks to minimize the number of component transactions (e.g., by avoiding partial matches, by matching orders of like size, etc. . . . ).

Database 112 includes electronic storage (e.g., 404 of FIG. 4) of the system 100 and may include or be an order book. In certain examples, an order book stores electronic data messages (e.g., or the orders therein) that have been received from client computer systems 108. In certain implementations, two separately ordered lists are stored and maintained per identifier (e.g., per ticker symbol, CUSIP number, security identification number, or other asset or resource identifier). The two lists may correspond to the buy and sell or bid and ask “sides” of an order book for a ticker symbol. The messages (or the requests/orders included in those messages) may be sorted according to one or more of: price, size, order submitting entity, time of submission, time in the order book, etc. . . . . In certain examples, description information for the messages or orders is also included in the order book.

In certain examples, the database 112 may include a list of sell orders for each asset (e.g., that corresponds to how much of that asset is available) and a list of buy orders and eligible assets for each buy order. In this respect, the “buy” orders may be different from traditional buy orders (e.g., buy 100 @ 50) as they represent that the client is willing to buy a given asset, but not that such a transaction may occur. For example, order 210A in FIG. 2 shows a buy order for 200 and eligible assets of A and C. This means that the client that submitted buy order 210A is looking to buy up to 200 A and/or C, where the price the client is willing to pay for A is 95 and the price the client is willing to pay for C is 90. The actual transaction(s) that are determined to fulfil this buy order 210A may vary depending on the outcome of the auctions for A and/or C. For example, in one instance, 200 of A may fulfil the client's order and 0 of C. In another instance, 25 of A and 175 of C may be used to fulfill the order. In other instances, 50 of A and 50 of C may be determined (e.g., the auctions for A and C did not have enough sell orders to satisfy all of this buy order).

In certain example embodiments, the auction process that is carried out for each individual auction (e.g., Auction A 206A, Auction B 206B, etc. . . . ) uses a standard auction process. In certain examples, the auction process operates according to the process shown in FIGS. 3A-3C. In certain examples, the auction process operates in accordance with the examples described in connection with tables 1 and 2 herein.

Client systems 108 may include personal computers, PDAs, cell phones, server computers, or any other system/devices configured to electronically communicate (via electronic data messages) with the computer-implemented auction system 100 via an electronic data communications network (e.g., the Internet or other computer-based network).

Client systems 108 can be associated with an individual and/or business entity (e.g., a retail broker or an individual trader) that submits orders to the auction system 100 by using electronic data messages.

Client systems 108 include a central processing unit (CPU), a memory, and a data transmission device. The data transmission device can be, for example, a network interface device that connects the client system to an electronic data communications network. The connection can be wired, optical, or wireless and can connect over a Wi-Fi network, the Internet, or a cellular data service, for example. In certain examples, client systems 108 may have a dedicated connection to the auction system 100. The data transmission device is or includes, in some embodiments, a transceiver, baseband processor, network interface device, and/or other data communications circuitry, and is capable of sending and receiving data. Data may be received and/or transmitted by way of data packages or packets—e.g., electronic data messages.

The client systems 108 are used for interacting with the auction computer system 100. For example, a given client system can be used to create electronic data messages relating to the placement of orders for buying or selling securities/assets and transmitting electronic data messages related to such requests to the auction system 100. The client system 108 can take details of an order (e.g., via inputs provided through a keyboard or other input device) from a user to buy or sell a certain number of shares and send the order the auction system 100.

Generally, client computer systems 108 are controlled by a “Client” or a “participant” that is an entity that benefits from auctions via orders. This also includes orders submitted on behalf of different clients (e.g., via a Financial Advisor or broker institution).

### Description of FIG. 2

FIG. 2 shows an illustrative view of how a group of multiple different assets that have individually performed auction processes are handled using the system of FIG. 1. In this example, the group of assets corresponds to a “fund” that is offered by an entity (e.g., an individual, business, broker, a limited partnership interest, etc. . . . ). Here, Fund X 200 includes Asset A 202A, Asset B 202B, Asset C 202C, and Asset D 202D. Fund X 200 and each of the assets in that fund may be identified in the computer system 100 via unique identifiers (e.g., ticker symbols) that may be, for example, stored in database 112. Each of the assets also have a corresponding auction, Auction A 206A, Auction B 206B, Auction C 206C, and Auction D 206D. The four auctions form auction group 204. Auction group 204 nominally corresponds to Fund X 200. However, other assets from other funds (or even individual assets) could be included in a single auction group. Auction group 204 and the auctions therein may also be identified by the computer system 100 via unique identifiers.

In certain examples, different assets includes assets that, for example, correspond to the same or similar underlying instrument, security, or the same ticker symbol (e.g., such that the underlying instruments may be interchangeable or materially the same), but that have different characteristics or properties associated therewith. The different assets may thus be linked to one another (e.g., by the underlying asset or other association), but be distinguished based on different fee structures, legal structures, ownership rights, voting rights, transferability rights, and the like. As an example of the different assets—each with their own individual auctions in a sequential auction process—one may have a fee of 0.5% and another may have a fee of 1%. Each asset that has their own corresponding auction may be identified (e.g., uniquely) by the system 100 (and by participants that place orders for the different assets). As used herein, different assets may include different classes or types of the same asset. As used herein, shares of a given asset include interest in the asset, units of the asset, or other divisor of the asset.

Once an auction process is initiated (or before), sell orders 208A, 208B, 208C may be received for assets A, B, and C. These sell orders are used to determine the total amount of each asset that is available at a given auction (206A, 206B, 206C, 206D).

During the auction process for the auction group 204, clients may also submit buy orders 210A and 210B. As discussed herein, a buy order can include an amount of the auction group that a client wishes to buy, the particular assets of the group that the amount will be applied against, and corresponding bid prices for each asset of the group.

In another example embodiment, buy orders may be placed for specific assets (as opposed to a group) and sell orders are placed against an asset group.

As discussed herein, in one example implementation, upon reception of each new order a calculation process is executed that determines the auction price and auction amount for each of the scheduled auctions. This information can then be exposed to various services. In certain examples, this information can be provided to auction administrators in order to provide surveillance or operational oversight, to issuers who desire visibility into this information, or other services.

### FIGS. 3A, 3B, and 3C:

FIGS. 3A, 3B, and 3C are signal diagrams that show how a sequenced auction process operates using the example system shown in FIG. 1.

At 300, database 112 is configured with a list of assets and information that defines which assets belong to which groups (e.g., that Assets 202A, 202B, 202C, and 202D in FIG. 2 all are grouped under fund X 200—where each may be identified by a corresponding unique identifier). This configuration may be a manual process or may be imported from other systems (e.g., external system 110).

At 301, auction computer system 100 begins the auction process. This may include sending notifications to client systems 108 that the auction has begun. In certain examples, the triggering of the beginning of the auction process is manual and in other examples the auction starts at a preset time arranged in advance.

At 302, client systems 108 receive auction notification messages that the auction has started for a given group of assets. In certain examples, this notification is sent from auction system 100. However, such notifications may be sent from other computer systems.

During the auction process, the auction computer system 100 has a time period where new orders (buy and/or sell orders) may be accepted. This is represented at steps 304 and 306, respectively. However, at any time between 301 and 320, client systems 108 may submit orders to the auction computer system 100. Orders that are submitted are added to the database 108 by the transaction request handler 103 at 307.

At 308, the transaction request handler 103 communicates with the scheduling engine 104A to conduct a “partial” sequenced auction process (e.g., where a plurality sequenced auctions are performed) in response to reception of a new buy or sell order. In certain examples, upon reception of a new order, a partial sequenced auction process is performed in order to give real time visibility into the current state of the auction that is underway. This may include calculating the current auction prices and commitment amount (e.g., the number of shares that will be transacted according to the current state of the auction). In certain examples, 308 is performed in response to reception of just buy orders, just sell orders, or either buy and sell orders.

The sequenced auction process that is conducted (starting at 308) may be a “partial” process because certain features of a “full” auction process may not be performed at this stage of in the auction. In particular, while the auction is still underway, only those elements of the auction that are needed to provide real-time data on the current state of the auction may be performed. Other aspects that are part of the full auction process (e.g., as described in connection with 322-338), such as matching individual buy and sell orders to form transactions, may not be performed during this “partial” sequenced auction process as they do not provide the desired data. However, in certain alternative implementations, the full sequenced auction process may be performed in response to the reception of each order.

As part of the partial execution of the sequenced auction process, at 309, the scheduling engine 104A determines the sequence of the auctions for the fund for which the incoming order at 304 or 306 was associated. In other words, the order for the individual auction processes will be determined. The determination of the sequence of the auctions may be dynamic (e.g., based on the contents of the various received orders), static (e.g., based on the properties of the assets), or predefined (e.g., manually set to a particular order by a user). In certain examples, the order of the auction may be set (e.g., prior to the auction) and then stored in a static state in the database 112.

Next, in FIG. 3B, the scheduling engine 104A initiates the calculation process at 310 for a given asset in the sequenced auction process. This may be accomplished by the scheduling engine 104A invoking a calculation process executed by the calculation engine 104B. This process occurs for each of the assets in the sequenced auction process (as represented by the loop between 318 and 310).

At 312, the calculation engine 104B retrieves eligible orders from the database 112 for the asset for which the price is being calculated. The sell orders that are retrieved may be sorted from the lowest to the highest price, and then by time (e.g., a timestamp for when the sell order was received by the system) from the earliest to the latest. Thus, the first sell order used in the process may be the lowest price with the earliest timestamp.

Buy orders may be sorted from the highest price to the lowest, with those buy orders that have indicated interest in the current asset being added as buy orders to an order book for the given asset.

The calculation process may use the following variables: 1) current clearing price—stores a clearing price computed during the current iteration; 2) current clearing amount—stores a clearing amount computed during the current iteration; 3) previous clearing price—stores clearing price computed during the previous iteration; 4) previous clearing amount—stores clearing amount computed during the previous iteration; 5) current sell clearing amount—stores sum of all commitments from sell orders processed by the sell loop so far; 6) current buy clearing amount—stores sum of all commitments from buy orders processed by the buy loop so far. These variables may all be initialized to zero.

The calculation of the price and amount at 314 may proceed as follows:

Part 1) For each sell order

1.1) Calculate the current sell clearing amount by adding the commitment amount of the current sell order to the current clearing amount (e.g., the total amount of the given asset that is available).

1.2) For each buy order one of the following 3 choices is performed:

a) Stop further processing of buy orders: If the buy order price is smaller than current clearing price or current buy clearing amount is bigger than current sell clearing amount then stop processing.

b) Skip the current buy order and continue with the next buy order: If the buy order price is smaller than sell order price then continue to next buy order.

c) Update the current buy clearing amount and continue with the next buy order: Add the commitment of the current buy order to the current buy clearing amount and continue to next buy order.

1.3) After looping from the buy orders in 1.2, then the process calculates the current clearing price and current clearing amount. In particular, if at least one buy order has been processed by the buy order loop, set the current clearing price to the average (e.g., the midpoint) of the current sell order price and the last processed buy order price. Alternatively, if no buy orders were processed by the buy order loop, then set the current clearing price and amount to zero.

1.4) Finally, if the current clearing price multiplied by current clearing amount is less than or equal to previous clearing price multiplied by previous clearing amount, then the sell loop stops processing and uses the previous clearing price and previous clearing amount as the final result (e.g., the price and amount that will be used or provided for this auction in the sequenced auctions). If, however, the current clearing price multiplied by current clearing amount is larger than previous clearing price multiplied by previous clearing amount, then the Loop continues with the next order (e.g., returns to 1 above).

Accordingly, by using the above example technique a clearing price and clearing amount may be calculated based in the buy and sell order lists for a given asset that is part of a sequenced auction. These two pieces of calculated data (first and second data) may then be used in the processing for subsequent auction processes (e.g., the transaction processing for those auctions that determines what the price, amount, and/or which orders are to be matched). Accordingly, in certain examples, the results of processing initial auctions (e.g., the first auction in a sequenced process) may affect how subsequent auction are carried out.

As described in greater detail below, there may be another part of step 314 that is performed related to resolving or checking for all-or-nothing orders (AON) and updating the fill status of each order.

In any event, the data that is calculated in step 314 may be saved to the database 112 in 316. In certain instances, the data may then be output to a display or electronic data feed to provide a real-time view of the current auction statistics of each auction of the sequenced auctions.

In certain examples, the triggering of 310-318 is done only for incoming sell orders or only for incoming buy orders. Accordingly, the reception of one type of order (e.g., a first type, such as, for example, sell orders) may trigger processing 310-318, while the reception of another type of order (e.g., a second type, such as, for example, sell orders) may not trigger that same processing.

At step 318, the process repeats for the next auction (e.g., the auction for the asset with the next highest fee, etc. . . . ).

At 320, the auction computer system 100 closes the auction process to new orders. It will be appreciated that new orders may be received at any time between the start (301) and end (320) of the auction.

After closing the auction, the scheduling engine 104A invokes the calculation process of the calculation engine 104B of the respective auction. As discussed above, there are a variety of different techniques for sequencing the auctions, but in one example embodiment the assets are arranged from the lowest to highest fee and the auctions for those assets as similarly scheduled at 322.

For each of the different auctions, the calculation engine 1048 retrieves the list of orders for that particular sequenced auction at 324 and calculates the clearing price and clearing amount at 326. The process for 326 is similar or the same to that of 314 and the results are saved at 328. In certain examples, step 326 may be skipped and the price and amount saved during the last triggering of 314 may be used as input for 330. In certain examples, 330 may be skipped as well (e.g., if the process detailed in 330 was included in the loop between 310 and 318. Thus, in certain examples, the match process 334 may be performed based on data previously stored in the database.

In any event, with the calculated clearing price and clearing amount, the calculation engine 104B then checks the AON status and determines the fill status of each order at 330. The AON process may use a variable to store data above the remaining clearing amount. This variable may be used to represent the clearing amount not processed by a previous round. In certain examples, the clearing amount determined in 326 is used to initialize this value. The process at 326 may include the following elements.

1) Check AON and fill sell orders

1.1) For each sell order in the list there are one of two possible options:

1.1.1) If the given sell order's commitment amount is greater than remaining clearing amount then the remaining clearing amount is set to zero. In certain examples, the remaining clearing amount is the clearing amount that was not processed by the prior sequenced auction (e.g., the prior round). The remaining clearing amount value may be initialized to the clearing amount calculated above (e.g., that is saved at 328). The order status is set to partially matched and the matched amount is set to the remaining clearing amount. If the order is an AON order then it is removed from the list of orders and the current auction is recalculated for this given asset. In other words, an all-or-nothing order could only be partially matched so the process removes it from the list of orders and reruns the calculation process (e.g., reruns 326 and/or 330). When the all-or-nothing order is removed and the calculation process is rerun, the remaining orders are set to unmatched.

1.1.2.) If the sell order's commitment amount is less than or equal to remaining clearing amount subtract the order's commitment amount from remaining clearing amount and set the remainder as the new remaining clearing amount. The sell order is then set to fully matched (e.g., to the full matched amount). The next sell order is then processed.

2) After processing the sell orders, the buy orders are similarly checked. As with the sell orders there are two possible options (fully matched or less than fully matched—including those orders not matched at all).

2.1) If the buy order's commitment amount is greater than the remaining clearing amount, then set the remaining clearing amount to zero. The order status of the buy order is set to partially matched and the matched amount is set to the remaining clearing amount. If the buy order is an AON order, remove it from the list of buy orders for this auction and rerun the calculation process without it. The remaining buy orders may also be set to unmatched before the rerun process occurs. It will be appreciated that when an all-or-nothing order is removed that its removal may affect more than one auction. For example, a buy order marked all or none that indicated 3 different assets may cause the recalculation of the auctions for those 3 assets if the process determines that the buy order cannot be completely fulfilled.

2.2) If the buy order's commitment amount is less than or equal to remaining clearing amount, the buy order's commitment amount is subtracted from remaining clearing amount. The remainder is saved as the new remaining clearing amount. The buy order is set to fully matched (e.g. its matched amount is set to its commitment amount) and the next buy order is processed.

2.3) If a buy order is fully matched, then it is removed completely from the sequence of auctions. If, however, a buy order is unfilled, or partially filled, it moves onto the next one of the sequenced auctions (e.g., the next round).

At the conclusion of the AON and fill status part of the calculation process the list of buy and sell orders that are to matched (e.g., those have been filled or partly filled) may be saved to the database 112 along with a list of buy orders (and their commit amounts) that are to be used in the next round.

At step 334, the matching engine 104C is invoked to generate transactions between the list of buy and sell orders determined by 330 and saved at 332. This process may include the following variables, the current sell order (the current sell order being processed), the current buy order (the current buy order being processed), the current list of sell orders (the list of all sell orders to process for matching), and the current list of buy orders (the list of all buy orders to process for this matching part of this round of the sequenced auction process). The process may generate a list of transactions between buy and sell orders. The matching process includes the following steps that operate in a loop:

1) Get the current sell order (or stop processing) by removing it from the current list of sell orders. If there are no more orders, the process ends.

2) Get the current buy order (or stop processing) by removing it from the current list of buy orders.

3) With the two orders, one of three possible actions are taken:

3.1) If the current buy order commitment is larger than the current sell order commitment then add a transaction from the seller to the buyer for the amount of current sell order. The current buy order commitment is decreased by the current sell order commitment and steps 1 and 3 are rerun. In certain instances, the selection of a buy order (step 2) may be skipped as a buy order is already selected.

3.2) If the current buy order and sell order commitments are equal, then a transaction from the sell to the buyer is added, and steps 1-3 are rerun.

3.3) If the buy order commitment is smaller than the sell order, then a transaction is added from the seller to the buyer for the amount of the buy order. The sell order commitment is decreased by the current buy order commitment and steps 2 and 3 are repeated.

Accordingly, a list of transactions (e.g., at the clearing price) may be generated based on the previously generated list of buy and sell orders and saved to database 112 at 336.

The process of calculating the clearing price, fill status, and matching is repeated for each auction round of the sequenced auction process at 338.

When the sequenced auction is finished, the results of the auction may be reported to client systems 108 at 340.

The following is an embodiment for how a sequential auction process may be performed. In certain examples, the following may be implemented using system 100 of FIG. 1 and/or in accordance with the process shown in FIGS. 3A-3C. Table 1 shows multiple different sell orders that are received for an example sequential auction and Table 2 shows buy orders for the sequential auction.

TABLE 1

| ID | Amount | Class | Price | PPS |
|---|---|---|---|---|
| 1226 | 1000 | B | 6000 | 6 |
| 1227 | 300 | B | 2100 | 7 |
| 1228 | 200 | B | 2400 | 12 |
| 1229 | 100 | B | 1500 | 15 |
| 1230 | 1000 | A | 5000 | 5 |
| 1231 | 300 | A | 2550 | 8.5 |
| 1232 | 200 | A | 1800 | 9 |
| 1233 | 100 | A | 950 | 9.5 |

TABLE 2

| Order ID | Amount | Class | Price | PPS |
|---|---|---|---|---|
| 968 | 1000 | A\|B | 15000.0\|15000.0 | 15\|15 |
| 969 | 700 | A\|B | 7000.0\|7700.0 | 10\|11 |
| 970 | 500 | A\|B | 3500.0\|4500.0 | 7\|9 |
| 971 | 300 | B | 2400 | 8 |
| 972 | 600 | A | 3600 | 6 |

Tables 1 and 2 show, respectively, sell and buy orders submitted by different participants (e.g., via client system 108) to system 100.

In some implementations, an order may be provisionally included into the order book (e.g., included in order book 112 and/or the above table) and removed at a later point in time if one or more conditions are not met. In such instances, the provisional order may be considered “incomplete.” An order may be a provisional order if it is conditioned upon the completion of an external check or process. As an example, a participant may submit a provisional order that is included into the order book (e.g., the above table that is stored in order book 112), but the order may be conditioned upon approval or submission of executed legal documents for that order. If the required documents are not submitted, the provisional order may be removed from the order book. If the required documents are submitted, the order may be changed (e.g. updated) from a provisional order to a “complete” order and processed like the other normal orders within the order book. In certain examples, an order may be marked as provisional via a bit field or the like.

As shown in the above tables, there are two different assets (A and B) in the sequential auction process. Asset B has a fee structure of 0.5% and Asset A has a fee structure of 1%. In this example, the assets are ordered for the sequential auction from the lowest fee structure to the highest fee structure—so the auction for asset B will occur first, followed by the auction for asset A.

For the auction for Asset B, the price and amount are first calculated. The process of calculating the price and amount begins with selecting the lowest sell price and the highest bid price for Asset B. From this, order 1226 and 968 are selected. The midpoint between these two orders is $10.50 and accordingly the total amount that would be transacted at this price is $1,000.

The process continues looking at the orders for a price that will increase the amount that would be committed to the auction. Accordingly, orders 1227 and 969 are selected. The midpoint price between these orders is $9 and with this price the total commitment amount would be $1,300. It will be appreciated that the total commitment amount as used herein may instead be a “notional amount,” a quantity, or other numerical value.

Next, the process select order 1228 and order 968. The midpoint price of these orders is $13.50 and a total commitment amount would be $1,000. As the current commitment amount is less than the prior commitment amount, the previously calculated price ($9), with a total transaction value of $1,300, is used for filling the buy and sell orders.

Buy order 968, with a maximum price of $15 for $1,000 commitment (of $1,000 total commitment), will be executed in full for $1,000 commitment with total of $9,000 (the final auction price*the commitment amount). There is no leftover commitment amount for the remaining possible positions in A for order 968.

Buy order 969, with a maximum price of $11 for $700 commitment (of $700 total commitment), will be executed partially for $300 commitment (a total of $2,700=auction price*commitment amount). The left over amount for 969 is $400 ($700-$300) for asset A.

Buy orders 970 and 971 are not executed because the available commitment (of the original $1,300) has been exhausted.

Now the sell orders are filled. Sell order 1226, with $1,000 commitment and a minimum price of $6, is executed in full for $1,000 commitment at the auction price of $9 for a total of $9,000.

Sell order 1227, with $300 commitment and a minimum price of $7, is executed in full for $300 commitment at the $9 auction price for a total of $2,700. Sell orders 1228 and 1229 are not executed as there is no available commitment amount.

The initial calculation for auction for B is now completed and the auction for A is started. While it does not occur in this example, this calculation may be modified (e.g., as discussed in connection with step 330) in the event of an All or None order (e.g., an AoN order) that is partially executed during the auction for B and is not fully executed in the auction for A. For this reason every calculation for an auction is “initial” until all sequenced auctions are completed.

Like auction B, the price and amount are determined for auction A. First, a price of $5.50 is calculated using sell orders up to 1230 and buy orders up to 972. This results in a commitment amount of $1,000. For the next calculation a price of $9.25 is used from sell orders up to 1231 and buy orders 969. This results in a commitment amount of $400. As the commitment amount has decreased, the process traces back to the previous calculation where the auction price is determined to be $5.50 with a commitment amount of $1,000.

As with auction B, the buy orders are filled first, then the sell orders. Order 968 is not processed because its total commitment has already been executed for auction B. Buy order 969, with a maximum price of $10 and $400 commitment (of the original $700 commitment), is executed in full for $400 commitment at the $5.50 auction price for a total of $2,200. There are no leftovers or remaining positions.

Buy order 970, with a maximum price of $7 and $500 commitment (of $500 total commitment), is executed in full for $500 commitment at the $5.50 final auction price for a $2,750. There are no leftovers or remaining positions.

Buy order 972, maximum a price of $6 and $600 commitment (of $600 total commitment, is executed partially for $100 commitment at the $5.50 final auction price for a total of $550. There is a leftover amount of $500 commitment for order 972.

The sell orders are now filled, with sell order 1230, with a minimum price $5 and $1,000 commitment, being executed in full for $1,000 commitment at the auction price of $5.50 for a total of $5,500. This exhausts the available commitment amount for auction and accordingly none of sell orders 1231, 1232, or 1233 are executed. This concludes the sequential auction process and results in transactions being generated as described above.

### Description of FIG. 4

FIG. 4 is a block diagram of an example computing device 400 (which may also be referred to, for example, as a “computing device,” “computer system,” or “computing system”) according to some embodiments. In some embodiments, the computing device 400 includes one or more of the following: one or more processors 402; one or more memory devices 404; one or more network interface devices 406; one or more display interfaces 408; and one or more user input adapters 410. Additionally, in some embodiments, the computing device 400 is connected to or includes a display device 412. As will be explained below, these elements (e.g., the processors 402, memory devices 404, network interface devices 406, display interfaces 408, user input adapters 410, display device 412) are hardware devices (for example, electronic circuits or combinations of circuits) that are configured to perform various different functions for the computing device 400.

In some embodiments, each or any of the processors 402 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 402 uses an instruction set architecture such as x86 or Advanced RISC Machine (ARM).

In some embodiments, each or any of the memory devices 404 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 402). Memory devices 404 are examples of non-volatile computer-readable storage media.

In some embodiments, each or any of the network interface devices 406 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 408 is or includes one or more circuits that receive data from the processors 402, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 412, which displays the image data. Alternatively or additionally, in some embodiments, each or any of the display interfaces 408 is or includes, for example, a video card, video adapter, or graphics processing unit (GPU).

In some embodiments, each or any of the user input adapters 410 is or includes one or more circuits that receive and process user input data from one or more user input devices (not shown in FIG. 4) that are included in, attached to, or otherwise in communication with the computing device 400, and that output data based on the received input data to the processors 402. Alternatively or additionally, in some embodiments each or any of the user input adapters 410 is or includes, for example, a PS/2 interface, a USB interface, a touchscreen controller, or the like; and/or the user input adapters 410 facilitates input from user input devices (not shown in FIG. 4) such as, for example, a keyboard, mouse, trackpad, touchscreen, etc. . . .

In some embodiments, the display device 412 may be a Liquid Crystal Display (LCD) display, Light Emitting Diode (LED) display, or other type of display device. In embodiments where the display device 412 is a component of the computing device 400 (e.g., the computing device and the display device are included in a unified housing), the display device 412 may be a touchscreen display or non-touchscreen display. In embodiments where the display device 412 is connected to the computing device 400 (e.g., is external to the computing device 400 and communicates with the computing device 400 via a wire and/or via wireless communication technology), the display device 412 is, for example, an external monitor, projector, television, display screen, etc. . . .

In various embodiments, the computing device 400 includes one, or two, or three, four, or more of each or any of the above-mentioned elements (e.g., the processors 402, memory devices 404, network interface devices 406, display interfaces 408, and user input adapters 410). Alternatively or additionally, in some embodiments, the computing device 400 includes one or more of: a processing system that includes the processors 402; a memory or storage system that includes the memory devices 404; and a network interface system that includes the network interface devices 406.

The computing device 400 may be arranged, in various embodiments, in many different ways. As just one example, the computing device 400 may be arranged such that the processors 402 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 400 may be arranged such that: the processors 402 include two, three, four, five, or more multi-core processors; the network interface devices 406 include a first network interface device that implements Ethernet and a second network interface device that implements WiFi and/or Bluetooth; and the memory devices 404 include a RAM and a flash memory or hard disk.

As previously noted, whenever it is described in this document that a software module (e.g., such as an “engine”) or software process performs any action, the action is in actuality performed by underlying hardware elements according to the instructions that comprise the software module. Consistent with the foregoing, in various embodiments, each or any combination of the auction computer system 100, client system 108, external systems 110, network interface 106 and 106B, and hardware processor 102, each of which will be referred to individually for clarity as a “component” for the remainder of this paragraph, are implemented using an example of the computing device 400 of FIG. 4. In such embodiments, the following applies for each component: (a) the elements of the 400 computing device 400 shown in FIG. 4 (i.e., the one or more processors 402, one or more memory devices 404, one or more network interface devices 406, one or more display interfaces 408, and one or more user input adapters 410), or appropriate combinations or subsets of the foregoing) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 404 (e.g., in various embodiments, in a volatile memory device such as a RAM or an instruction register and/or in a non-volatile memory device such as a flash memory or hard disk) and all actions described herein as performed by the software modules are performed by the processors 402 in conjunction with, as appropriate, the other elements in and/or connected to the computing device 400 (i.e., the network interface devices 406, display interfaces 408, user input adapters 410, and/or display device 412); (c) alternatively or additionally, to the extent it is described herein that the component processes and/or otherwise handles data, in some embodiments, such data is stored in the memory devices 404 (e.g., in some embodiments, in a volatile memory device such as a RAM and/or in a non-volatile memory device such as a flash memory or hard disk) and/or is processed/handled by the processors 402 in conjunction, as appropriate, the other elements in and/or connected to the computing device 400 (i.e., the network interface devices 406, display interfaces 408, user input adapters 410, and/or display device 512); (d) alternatively or additionally, in some embodiments, the memory devices 402 store instructions that, when executed by the processors 402, cause the processors 402 to perform, in conjunction with, as appropriate, the other elements in and/or connected to the computing device 400 (i.e., the memory devices 404, network interface devices 406, display interfaces 408, user input adapters 410, and/or display device 512), each or any combination of actions described herein as performed by the component and/or by any software modules described herein as included within the component.

Consistent with the preceding paragraph, as one example, in an embodiment where an instance of the computing device 400 is used to implement the auction system 100, the memory devices 404 could load the files (e.g., executable programs or libraries) associated with transaction request handler 103, scheduling engine 104A, calculation engine 104b, and matching engine 104C, and/or store the data (e.g., data resulting for execution of 103-104C) described herein as processed and/or otherwise handled by the auction computer system, the client computer system 108, and/or external systems 110. Processors 402 could be used to operate the transaction request handler 103, scheduling engine 104A, calculation engine 104b, and matching engine 104C, and/or otherwise process the data described herein as processed by the auction computer system 100.

The hardware configurations shown in FIG. 4 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 4, (e) via other hardware arrangements, architectures, and configurations, and/or via combinations of the technology described in (a) through (e).

### Technical Advantages of Described Subject Matter

In certain examples, multiple separate transaction processes for different resources are treated as one transaction process from the perspective of a transaction requestor (a participant). This allows a participant to place a data transaction request (e.g., a single data transaction request) against a group of resources, where each of the resources has its own corresponding transaction process that is part of a larger organized sequence of transaction processes. Because the transaction processes are sequenced together, the execution of data transaction request from participants may be handled in a more efficient and flexible manner. In particular, this type of implementation allows for more efficient transaction processing because participants do not need to duplicate effort by submitting multiple data transaction requests for individually performed transactions processes. Instead, participants can submit transaction requests against a group, and the system can automatically adjust the data transaction requests as the data transaction processes are sequentially executed. This allows that one initial data transaction request to be involved in multiple different data transaction processes. Such implementations improve the overall processing efficiency of the system.

In certain examples, different resources (e.g., assets) are grouped together (e.g., into a single fund). With this type of implementation, a client can enter an order that limits their commitment amount across the entire fund and the multiple individual resources therein. As part of the order, the client can define unique prices for each asset within the fund.

The assets may be part of a sequenced auction process for the fund where multiple, individual auctions for the different assets in the fund are sequentially held. As the auctions are sequentially held, the continuity of a given multi-asset order (e.g., an order that can execute against multiple assets of the fund) may be maintained by keeping track of the amount matched for a given auction in comparison to the amount of the original commitment of the multi-asset order. Thus, as the order moves through the different auctions in the sequenced auction process the commitment amount may be gradually decreased. In certain examples, if a multi-asset order is flagged as an all-or-nothing order, but that order is not fully matched, then it may be removed from the entire auction sequence and the entire auction sequence may be recalculated for the fund—or at least those ones of the multiple auctions that the multi-asset order participated in.

Accordingly, with the techniques described herein, more efficient and flexible data transaction processing may be performed.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to 3A-3C, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system for processing a plurality of data transaction requests over a sequenced transaction process that includes a plurality of individual transaction processes that each correspond to a different one of a plurality of resources that each have a corresponding identifier, the plurality of resources being linked together, the computer system comprising:
a data storage system configured to store a plurality of data transaction requests, the plurality data transaction requests including at least those of a first type or a second type, wherein the plurality of data transaction requests that are of the first type each include: i) a total amount, and ii) an eligible list of the plurality of resources that the total amount is eligible to be processed against during the sequenced transaction process;
a processing system that includes at least one hardware processor, the processing system configured to:
determine an order in which the plurality of individual transaction processes are to be performed during the sequenced transaction process; and
perform the sequenced transaction process by performing each one of the plurality of individual transaction processes in the determined order;
wherein, for each of the plurality of individual transaction processes performed as part of the performed sequenced transaction process, the performing of the individual transaction process includes:
a) retrieving data transaction requests that are eligible to be processed by the individual transaction process, wherein the retrieved data transaction requests include those with the first type and an eligible list that includes the resource that corresponds to the individual transaction process,
b) calculating, based on the retrieved data transaction requests, first data and second data, and
c) storing the calculated first and second data.

2. The computer system of claim 1, wherein the processing system is further configured to perform the sequenced transaction process in response to reception of new data transaction requests.

3. The computer system of claim 2, wherein the sequenced transaction process is not performed in response to new data transaction requests that are of the second type.

4. The computer system of claim 2, wherein the processing system is further configured to:
close a period for when new transaction requests are accepted;
after the period, perform a closing sequenced transaction process in the determined order; and
as part of the closing sequenced transaction process, matching data transactions requests of the first type to data transaction requests of the second type.

5. The computer system of claim 4, wherein data transaction requests are not matched when the sequenced transaction process is performed in response to reception of new transaction requests.

6. The computer system of claim 1, wherein the performing of the individual transaction process further includes:
d) matching data transaction requests for the current resource based on the calculated first data, and
e) updating the plurality of data transaction requests that are available for subsequent individual transaction process based on the matching.

7. The computer system of claim 1, wherein the processing system is further configured:
determine that a first data transaction request is an all-or-nothing request; and
based on the first data transaction request not being completely matched, re-run the sequenced transaction process based on the first data transaction request being unfulfilled, wherein the unfilled first data transaction request is not used in the subsequent iteration of the sequenced transaction process.

8. The computer system of claim 7, wherein determination of all-or-nothing requests and complete matches for those requests is not performed during transaction processing that is performed in response to reception of new transaction requests.

9. The computer system of claim 7, further comprising:
a display device configured to output, in response to each calculation of the first and second data, a graphical user interface that displays the calculated first and second data.

10. A method of processing a plurality of data transaction requests over a sequenced transaction process that is executed on a computer system, the sequenced transaction process including a plurality of individual transaction processes that each correspond to a different one of a plurality of resources that each have a corresponding identifier, the method comprising:
storing a plurality of data transaction requests, the plurality data transaction requests including at least those of a first type or a second type, wherein the plurality of data transaction requests that are of the first type each include: i) a total amount, and ii) an eligible list of the plurality of resources that the total amount is eligible to be processed against during the sequenced transaction process;
determining an order in which the plurality of individual transaction processes are to be performed during the sequenced transaction process;
performing the sequenced transaction process by performing each one of the plurality of individual transaction processes in the determined order;
wherein each one of the individual transaction processes that are performed as part of the sequenced transaction process include transaction processing that includes:
a) retrieving data transaction requests that are eligible to be processed by the transaction process, wherein the retrieved data transaction requests include those with the first type and an eligible list that includes the resource that corresponds to the transaction process,
b) calculating, based on the retrieved data transaction requests, first data and second data, and
c) storing the calculated first and second data.

11. The method of claim 10, further comprising performing the sequenced transaction process in response to reception of new data transaction requests.

12. The method of claim 11, wherein the sequenced transaction process is not performed in response to new data transaction requests that are of the second type.

13. The method of claim 11, further comprising:
closing a period for when new transaction requests are accepted;
after the period, performing a closing sequenced transaction process in the determined order; and
as part of the closing sequenced transaction process, matching data transactions requests of the first type to data transaction requests of the second type.

14. The method of claim 13, wherein data transaction requests are not matched when the sequenced transaction process is performed in response to reception of new transaction requests.

15. The method of claim 10, wherein the transaction processing further includes:
d) matching data transaction requests for the resource based on the calculated first data, and
e) updating the plurality of data transaction requests that are available for subsequent individual transaction processes based on the matching.

16. The method of claim 10, further comprising:
determining that a first data transaction request is an all-or-nothing request; and
based on the first data transaction request not being completely fullfilled, re-run the sequenced transaction process based on the first data transaction request being unfulfilled, wherein the unfilled first data transaction request is not used in the subsequent rerunning of the sequenced transaction process.

17. The method of claim 16, wherein determination of all-or-nothing requests and complete matches for those requests is not performed during transaction processing that is performed in response to reception of new transaction requests.

18. The method of claim 16, further comprising:
in response to each calculation of the first and second data, outputting, to a display device, updates to a graphical user interface that displays the calculated first and second data.

19. A non-transitory computer readable storage medium storing computer executable instructions for use with a computer system that processes a plurality of data transaction requests over a sequenced transaction process that includes a plurality of individual transaction processes, where each of the plurality of individual transaction processes corresponds to a different one of a plurality of resources that each have a corresponding identifier, the stored computer executable instructions comprising instructions that cause the computer system to:
store, to a storage system of the computer system, a plurality of data transaction requests, the plurality data transaction requests including at least those of a first type or a second type, wherein the plurality of data transaction requests that are of the first type each include: i) a total amount, and ii) an eligible list of the plurality of resources that the total amount is eligible to be processed against during the sequenced transaction process;
determine an order in which the plurality of individual transaction processes are to be performed during the sequenced transaction process;
perform the sequenced transaction process based on the determined order;
as part of the sequenced transaction process, perform, a first transaction process of the sequenced transaction:
a) retrieve data transaction requests that are eligible to be processed by the first transaction process, wherein the retrieved data transaction requests include those with the first type and an eligible list that includes the resource that corresponds to the first transaction process;
b) calculate, based on the retrieved data transaction requests, first data and second data;
c) store the calculated first and second data; and
repeat, as part of the performed sequenced transaction process, at least a)-c) for a remainder of the individual transaction processes that are included in the sequenced transaction process, wherein the remainder is performed according to the determined order.

20. The non-transitory computer readable storage medium of claim 19, wherein the sequenced transaction process is performed in response to reception of new data transaction requests.
